(19) United States
(12) Patent Application Publication
(10) Pub. No.: US 2009/0141484 A1
(43) Pub. Date: Jun. 4, 2009

(54) Liquid and/or touch activated aquatic light

(76) Inventors: Nelson Jorge Torres, Miami, FL (US); Nelson Bernardino Torres, Miami, FL (US)

Correspondence Address: Nelson J Torres, 572 NW 74 Ave, Miami, FL, 33126, US

(21) Appl. No.: 12/288,156

(22) Filed: Oct. 17, 2008

Related U.S. Application Data
(60) Provisional application No. 61/004,731, filed on Nov. 30, 2007.

(51) Int. Cl. F21V 31/00

(52) U.S. Cl. 362/158

(57) ABSTRACT

A water and/or touch activated aquatic light, comprising: a watertight encasing; a battery mounted inside the encasing; a lamp mounted on and/or in the encasing; a pair of electrodes exposed on the exterior; an electronic switch responsive to current flowing through a conductive liquid path between said electrodes; and wherein the watertight encasing is sized and shaped so that the aquatic light floats, sinks, and/or has a neutral buoyancy and is to be used in an aquatic environment where in it may be used as a flashlight, a bait light, a dive light, a lure light, etc.

### TECHNICAL FIELD OF THE INVENTION

The present invention is directed to lights, and more particularly to aquatic lights.

### BACKGROUND OF THE INVENTION

In general, an aquatic light is a portable electric light, such as a flash light configured to be used by a user. Aquatic lights are useful for a variety of different applications, including use for light in the outdoors, attracting fish closer to a boat, or as a source of light to see an object in dark waters.

Other portable electric lights, in the form of aquatic lights, are available for use by individuals. As examples, electric lanterns, key fobs, and flashlights are popular lights that may be used when in the outdoors.

### SUMMARY OF THE INVENTION

The following presents a simplified summary of some encasings of the invention in order to provide a basic understanding of the invention. This summary is not an extensive overview of the invention. It is not intended to identify key/critical elements of the invention or to delineate the scope of the invention. Its sole purpose is to present some encasings of the invention in a simplified form as a prelude to the more detailed description that is presented later.

In accordance with an encasing, a floating light is provided. The light includes contacts that close a circuit when the light is in water. The closed circuit provides a connection between batteries or another power source and a lamp, lighting the lamp. The light is sealed so that it floats when dropped in the water with buoyant material.

Other features of the invention will become apparent from the following detailed description when taken in conjunction with the drawings, in which:

### BRIEF DESCRIPTION OF THE DRAWINGS

FIG. 1 shows a side perspective view of the aquatic light in accordance with an encasing;

FIG. 2 shows a top view of the aquatic light;

FIG. 3, FIG. 4, and FIG. 5 shows a circuit that may be used for the aquatic light.

### DETAILED DESCRIPTION

In the following description, various encasings of the present invention will be described. For purposes of explanation, specific configurations and details are set forth in order to provide a thorough understanding of the encasings. However, it will also be apparent to one skilled in the art that the present invention may be practiced without the specific details. Furthermore, well-known features may be omitted or simplified in order not to obscure the encasing being described.

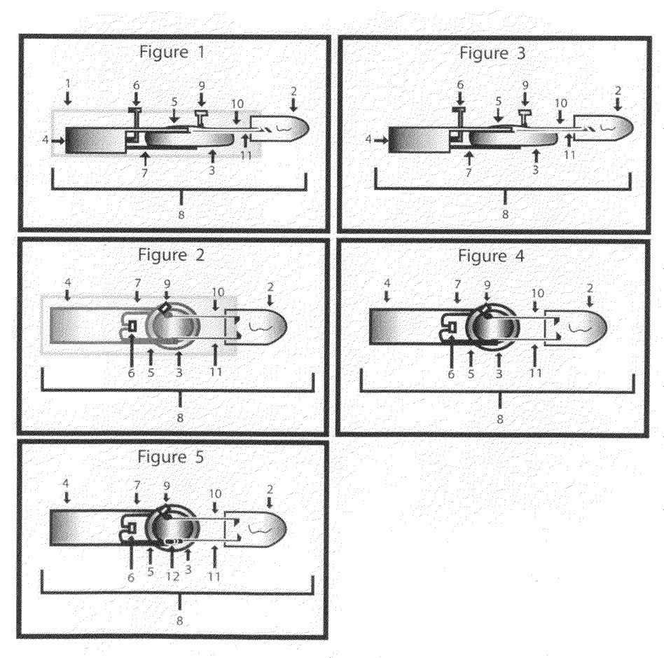

Referring now to the drawings, in which like reference numerals represent like parts throughout the several views, FIG. 1 shows an aquatic light 8 in accordance with an encasing of the invention. The aquatic light 8 includes an encasing 1 having waterproof properties. The encasing 1 forms a seal between the light emitting diode 2, the battery 3, and the transistor 4. Although a light emitting diode is shown, the aquatic light may include any form of lamp, an incandescent lamp, a fluorescent lamp, or other lamps or lights.

The aquatic light 8 includes a battery 3 and/or batteries 3 mounted inside of the encasing 1. As an alternate to batteries 3, a rechargeable battery or batteries may be used within the encasing 1.

The encasing contains the battery were the negative and positive terminals of the batteries 3 connect to the LED 2 and the transistor 4, respectively. The negetive terminal from the battery 3 is connected to the collector 7 leg. The positive terminal of the battery 3 is connected to the positive leg 10 for the LED 2. A wire 9 extends from the battery 3 positive terminal to the outside of the encasing 1. The base 6 leg from the transistor 4 also extends outside the encasing 1. The emitter 5 leg connects to the negetive leg 11 of the LED 2. Additionally a resistor 12 may be added between the negative leg 11 of the LED 2 and the emitter 5 leg of the transitor.

In the encasing shown in FIG. 1, the aquatic light 8 floats. That is, the aquatic light 8 stays at a top surface of a body of water, even if only a slight portion or none of the aquatic light extends above a surface of the water. The floatation provided may be sufficient only to make the aquatic light buoyant. To this end, the aquatic light 8 is preferably sized so that the buoyant material, for example behind the LED 2, is sufficient to support the aquatic light 8 along with the battery 3, when the aquatic light 8 is dropped in water. For the aquatic light 8 shown in FIG. 1, a buoyant material is provided for this function, although air pockets may be formed at any location so as to provide this function. The amount of boyant material needed to float a aquatic light 8 may be determined empirically or by experimentation. In addition, the aquatic light 8 may be floatable in other ways, for example by the addition of Styrofoam or other buoyant materials.

FIG. 1 also shows the exterior of the aquatic light 8, and is helpful in showing that the base 6 leg and the wire 9 are exposed on the exterior of the aquatic light 8. The wire 9 and the base 6 leg are positioned so that they are in contact with water when the aquatic light 8 is floating, regardless of the orientation of the aquatic light 8. In the encasing shown in the drawings, as can be seen in FIG. 1, the aquatic light is mostly submerged when floating at a surface of the water.

Although the aquatic light 8 is shown on its side at the surface of the water, an aquatic light may be configured in a different manner so that a different portion is presented at the surface. As an example, an aquatic light may be configured to float upside down.

As can be understood, the aquatic light 8 the present invention is very useful when night aquatic. Not only does the aquatic light 8 float, but, the aquatic light 8 will only turn on the LED 2 when the water is arcing across the base 6 and the wire 9.

In the encasing shown in FIG. 2, the aquatic light 8 sinks. That is, the aquatic light 8 stays below the surface of a body of water, even if only a slight portion or none of the aquatic light extends above the surface of the water. The weight provided may be sufficient only to make the aquatic light sink. To this end, the aquatic light 8 is preferably sized so that the weight formed, for example behind the LED 2, is sufficient to sink the aquatic light 8 along with the battery 3 when the aquatic light 8 is dropped in water. For the aquatic light 8 shown in FIG. 2, a weighted material is provided for this function. The amount of weighted material needed to sink a aquatic light 8 may be determined empirically or by experimentation. In addition, the aquatic light 8 may be sinkable in other ways, for example by the addition of lead or other weighted materials.

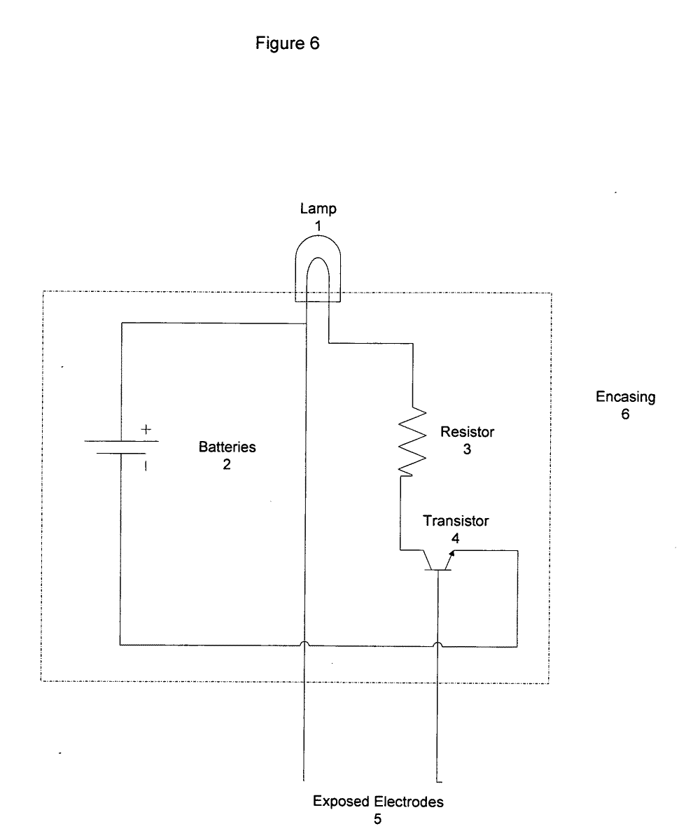

FIG. 3, FIG. 4, and FIG. 5 shows a top and side view of the interior of the encasing, respectively. This is helpful in showing how all the connections come together within the encasing. All connections are positioned to avoid any false contacts which may cause a short circuit whithin the encasing.

FIG. 6 shows the electrical schematic of the aquatic light. Lamp 1 has the positive leg connected directly to the battery and/or batteries 2. The negative leg is connected to the emitter leg of the transistor 4 with or without a resistor 3. The emitter leg of the transistor 4 is connected to the negative terminal of the battery and/or batteries 2. The base leg of the transistor 4 is positioned to be protruding outside of the encasing 6 along with an additional wire that is connected to the positive side of the battery and/or batteries 2 which are labeled as exposed electrodes 5.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate encasings of the invention and does not pose a limitation on the scope of the invention unless otherwise claimed. No language in the specification should be construed as indicating any non-claimed element as essential to the practice of the invention.

Preferred encasings of this invention are described herein, including the best mode known to the inventors for carrying out the invention. Variations of those preferred encasings may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A water activated aquatic light, comprising: a watertight encasing; a battery mounted inside the encasing; a lamp mounted on and /or in the encasing; a pair of electrodes exposed on the exterior; an electronic switch responsive to current flowing through a conductive liquid path between said electrodes; and wherein the watertight encasing is sized and shaped so that the aquatic light floats, sinks, and/or has a neutral buoyancy and is to be used in an aquatic environment where in it may be used as a flashlight, a bait light, a dive light, a lure light, etc.

2. The aquatic light of claim 1, wherein the power supply is one or more batteries.

3. The aquatic light of claim 1, wherein the lamp comprises a member of the set of one or more light emitting diode(s), an incandescent lamp(s), and/or a fluorescent lamp(s).

4. The aquatic light of claim 1, wherein the lamp comprises of a blinking or steady light; and/or the lamp color is white, blue, green, RGB, and/or any other color combination
